(19) United States
(12) Patent Application Publication
(10) Pub. No.: US 2026/0299289 A1
(43) Pub. Date: Oct. 1, 2026

(54) ADJUSTABLE LIQUID CORRECTIVE LENS

(71) Applicant: Valve Corporation, Bellevue, WA (US)

(72) Inventor: Joshua Hudman, Bellevue, WA (US)

(21) Appl. No.: 19/630,986

(22) Filed: Mar. 27, 2026

Related U.S. Application Data
(60) Provisional application No. 63/778,812, filed on Mar. 27, 2025.

(51) Int. Cl. G02B 27/00; G02B 27/01

(52) U.S. Cl. CPC G02B 27/0068; G02B 27/0172; G02B 2027/011

(57) ABSTRACT

An adjustable lens assembly includes a first optical element having a first edge, a second optical element having a second edge, and a fluid volume disposed between the optical elements. One or more actuators are configured to adjust a distance between the first edge and the second edge to change an optical property of the lens assembly. The change in the optical property May include adjustments to optical power, correction for astigmatism, and/or spherical correction. The optical elements may be formed of a semirigid plastic. The lens assembly may be integrated into a head-mounted display.

### CROSS-REFERENCE TO RELATED APPLICATIONS

This application claims the benefit of U.S. Provisional Application No. 63/778,812 filed Mar. 27, 2025, the entire contents of which are hereby incorporated for all purposes in their entirety.

### BACKGROUND

The following disclosure generally relates to head-mounted displays. A head-mounted display (HMD) is an electronic device or system worn on a user's head and, when worn, secures at least one electronic display within a viewable field of at least one of the user's eyes, regardless of a position or orientation of the user's head. An HMD used to implement virtual reality (VR) typically envelop a wearer's eyes completely and substitute a “virtual” reality for an actual view (or actual reality) in front of the user. An HMD for augmented reality (AR) can provide a semi-transparent or transparent overlay of one or more screens in front of a wearer's eyes such that an actual view is augmented with additional information. In some AR devices, the “display” component of an HMD can be transparent or at a periphery of the user's field of view so that it does not completely block the user from being able to see their external environment. In some AR devices, a display overlays digital content on a video feed from a camera acquiring images of a real scene. Mixed Reality (MR) is an interaction between a digital and the physical world. Extended Reality (ER) can be used to refer to VR, AR, and/or MR.

### BRIEF SUMMARY

This disclosure generally relates to corrective lenses, and, without limitation, to a corrective lens for a head-mounted display.

In some configurations, an assembly for optical correction includes a first optical element having a first edge and a second optical element having a second edge. A fluid volume is disposed between the first optical element and the second optical element. A plurality of actuators is distributed around a periphery of at least one of the optical elements and configured to expand or decrease a distance between the first edge and the second edge at multiple locations. The actuators are arranged to change an optical property of the arrangement to correct for an optical power, astigmatism, and/or spherical correction. For example, the actuators can be adjusted in unison to correct for power or independently to apply forces unevenly around the periphery to warp the optical elements for astigmatism or aspheric correction. In some configurations, the optical elements comprise semirigid plastic lenses configured to maintain a baseline shape in the absence of external mechanical forces and under the force of gravity. The fluid within the volume may comprise an index-matching liquid, such as corn syrup, silicone oils, or glycerin. A reservoir in fluid communication with the volume may be included to allow for the adjustment of an amount of liquid between the optical elements as the edges are brought farther apart or closer together. Specifically, as the lens is adjusted to be positive, fluid moves into the reservoir; as it is adjusted to be negative, fluid moves from the reservoir into the volume between the optical elements. This technology can be integrated into a head-mounted display housing, such as within an eye tube, to provide personalized vision correction for a user. A user interface may guide a user through adjustments by presenting graphics on a display and receiving input to drive the actuators until a desired focus is achieved. Other applications include traditional glasses that can dynamically toggle between different prescriptions based on sensor data.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures.

FIG. 1 is a schematic diagram of an embodiment of a networked environment of a head-mounted display (HMD).

FIG. 2 is a diagram illustrating an embodiment of an environment for using an HMD.

FIG. 3 is a front pictorial diagram of an embodiment of an HMD having binocular display subsystems.

FIG. 4 illustrates a top plan view of an embodiment of an HMD having binocular display subsystems and various sensors.

FIG. 5 is a cross-sectional view of an embodiment of an apparatus for optical correction.

FIG. 6A is a diagram depicting an embodiment of an apparatus for optical correction in a neutral state.

FIG. 6B is a diagram depicting an embodiment of an apparatus for optical correction in a positive lens state.

FIG. 7 is an embodiment of an apparatus for optical correction including a fluid reservoir.

FIG. 8 is a flowchart illustrating an embodiment of a process for optical correction.

FIG. 9 is a flowchart illustrating an embodiment of a process for manufacturing an apparatus for optical correction.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

This disclosure generally relates to corrective lenses, and, without limitation, to a corrective lens for a head mounted display. One potential drawback of using a head-mounted display is that it can be challenging for a user to use the head-mounted display while also wearing glasses. One possible solution is to use inserts to correct vision. But a problem with using inserts is that several are often used to cover a majority people having vison problems, which may not work for some users. Additionally, users often do not know their optical prescription. And while inserts may be able to correct for power, inserts usually do not correct for astigmatism. To solve one or more of these problems, there is a need for improved ways to correct for vision in head-mounted displays.

One example solution is to use a liquid lens comprising a first optical element and a second optical element (e.g., two plano-convex lenses, each made out of plastic, bonded together at the vertexes with convex sides touching and plano sides facing outward), with a liquid (e.g., corn syrup) disposed between the first optical element and the second optical element. One or more actuators are used to adjust edges (e.g., to apply a mechanical force to) of the first optical element and/or the second optical element to be closer or farther apart. In some configurations, a reservoir is used to allow adjustment of an amount of liquid between the first optical element and the second optical element as edges are brought farther apart or closer together.

Though this description is focused on using a head-mounted display, such as for virtual reality (VR), liquid lenses described could be used in other applications. For example, a lens described could be used in traditional glasses. Glasses with a described lens can possibly be made more affordable and/or for adaptability for more people. In another example, a pair of glasses could dynamically change power (e.g., based on a tilt sensor, such as an inertial measurement unit (IMU)) to toggle between correcting for two different prescriptions instead of using bifocals (e.g., looking forward the liquid lens is adjusted to a first prescription for viewing objects at a distance, and a detection of a tilt to look downward adjusts the liquid lens to a second prescription to view objects that are near). Those skilled in the art will recognize other variations and applications.

For illustrative purposes, some embodiments are described below in which specific types of information are acquired and used in specific types of ways for specific types of structures and by using specific types of devices. However, it will be understood that such described techniques may be used in other manners in other embodiments, and that the present disclosure is thus not limited to the exemplary details provided. As a non-exclusive example, some embodiments include the use of images that are video frames. While an example may refer to a “video frame” for convenience, it will be appreciated that the techniques described with the example may be employed with respect to one or more images of various types, including non-exclusive examples of multiple video frames in succession (e.g., at 30, 60, 90, 180 or some other quantity of frames per second), other video content, photographs, computer-generated graphical content, other articles of visual media, or some combination thereof. Additionally, various details are provided in the drawings and text for exemplary purposes and are not intended to limit the scope of the present disclosure.

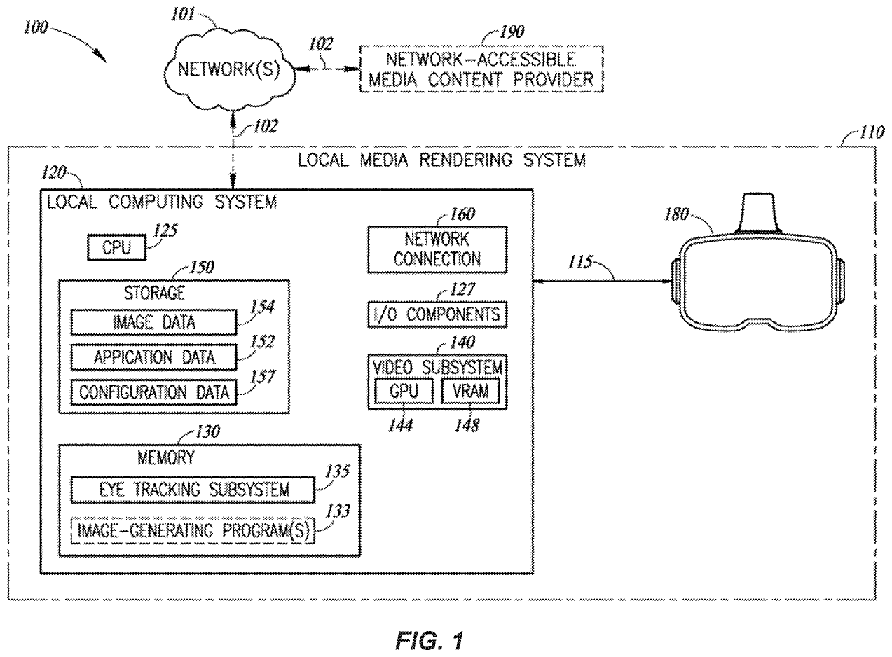

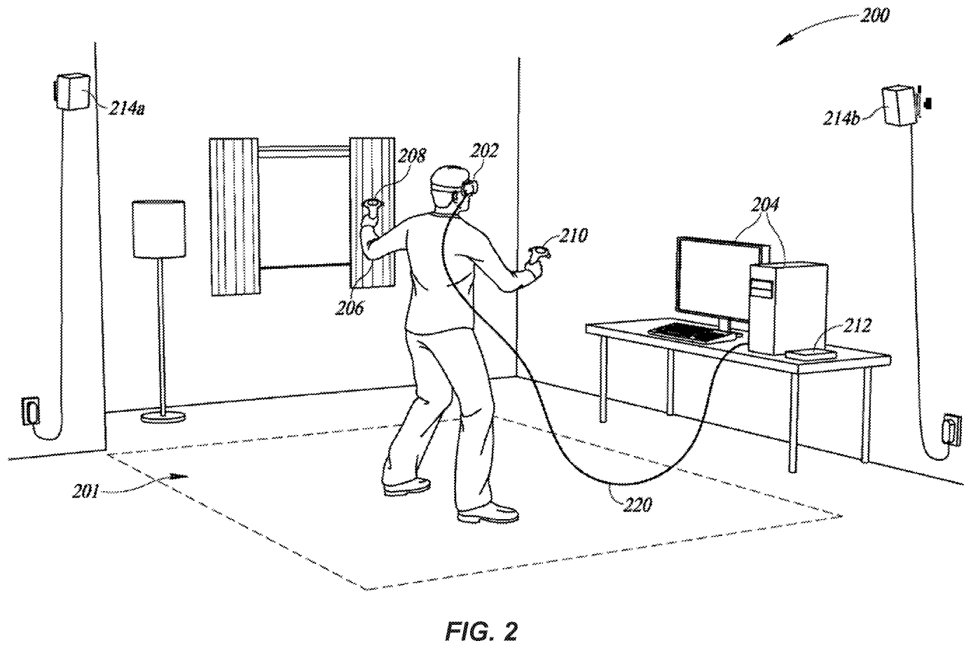

FIG. 1 is a schematic diagram of an embodiment of a networked environment 100. The networked environment 100 includes a local media rendering (LMR) system 110 (e.g., a gaming system), which includes a local computing system 120 and display device 180 (e.g., an HMD device with two display panels). In FIG. 1, the local computing system 120 is communicatively connected to display device 180 via transmission link 115 (which may be wired or tethered, such as via one or more cables as illustrated in FIG. 2 (cable 220), or instead may be wireless). In some embodiments, the local computing system 120 may provide encoded image data for display to a panel display device (e.g., a TV, console or monitor) via a wired or wireless link, whether in addition to or instead of the HMD device 180, and the display devices each includes one or more addressable pixel arrays. In some embodiments, the local computing system 120 may include a general purpose computing system; a gaming console; a video stream processing device; a mobile computing device (e.g., a cellular telephone, PDA, or other mobile device); a VR or AR processing device; or other computing system.

A pixel is the smallest addressable image element of a display that may be activated to provide a color value. In some cases, a pixel includes individual respective sub-elements (in some cases as separate “sub-pixels”) for separately producing red, green, and blue light for perception by a human viewer, with separate color channels used to encode pixel values for the sub-pixels of different colors. A pixel value refers to a data value corresponding to respective levels of stimulation for one or more of respective RGB elements of a single pixel.

In FIG. 1, the local computing system 120 has components that include one or more hardware processors (e.g., centralized processing units, or “CPUs”) 125, memory 130, various I/O (“input/output”) hardware components 127 (e.g., a keyboard, a mouse, one or more gaming controllers, speakers, microphone, IR transmitter and/or receiver, etc.), a video subsystem 140 that includes one or more specialized hardware processors (e.g., graphics processing units, or “GPUs”) 144 and video memory (VRAM) 148, computer-readable storage 150, and a network connection 160. An embodiment of an eye tracking subsystem 135 executes in memory 130 in order to perform one or more processes, such as by using the CPU(s) 125 and/or GPU(s) 144 to perform automated operations. The memory 130 may optionally further execute one or more other programs 133 (e.g., to generate video or other images to be displayed, such as a game program). As part of the automated operations, the eye tracking subsystem 135 and/or programs 133 executing in memory 130 may store or retrieve various types of data, including in the example database data structures of storage 150, in this example, the data used may include various types of image data information in database (“DB”) 154, various types of application data in DB 152, various types of configuration data in DB 157, and may include additional information, such as system data or other information.

The LMR system 110 is communicatively connected via one or more computer networks 101 and network links 102 to an exemplary network-accessible media content provider 190 that may further provide content to the LMR system 110 for display, whether in addition to or instead of the image-generating programs 133. The media content provider 190 may include one or more computing systems (not shown) that may each have components similar to those of local computing system 120, including one or more hardware processors, I/O components, local storage devices and memory, although some details are not illustrated for the network-accessible media content provider for the sake of brevity.

It will be appreciated that, while the display device 180 is depicted as being distinct and separate from the local computing system 120 in FIG. 1, in some embodiments, some or all components of the local media rendering system 110 may be integrated or housed within a single device, such as a mobile gaming device, portable VR entertainment system, HMD device, etc. In some embodiments, transmission link 115 may, for example, include one or more system buses and/or video bus architectures.

As one example involving operations performed locally by the local media rendering system 120, assume that the local computing system is a gaming computing system, such that application data 152 includes one or more gaming applications executed via CPU 125 using memory 130, and that various video frame display data is generated and/or processed by the image-generating programs 133, such as in conjunction with GPU 144 of the video subsystem 140. In order to provide a quality gaming experience, a high volume of video frame data (corresponding to high image resolution for each video frame, as well as a high “frame rate” of approximately 60-180 of such video frames per second) is generated by the local computing system 120 and provided via the wired or wireless transmission link 115 to the display device 180.

It will also be appreciated that computing system 120 and display device 180 are merely illustrative and are not intended to limit the scope of the present disclosure. The computing system 120 may instead include multiple interacting computing systems or devices, and may be connected to other devices that are not illustrated, including through one or more networks such as the Internet, via the Web, or via private networks (e.g., mobile communication networks, etc.). More generally, a computing system or other computing node may include any combination of hardware or software that may interact and perform the described types of functionality, including, without limitation, desktop or other computers, game systems, database servers, network storage devices and other network devices, PDAs, cell phones, wireless phones, pagers, electronic organizers, Internet appliances, television-based systems (e.g., using set-top boxes and/or personal/digital video recorders), and various other consumer products that include appropriate communication capabilities. The display device 180 may similarly include one or more devices with one or more display panels of various types and forms, and optionally include various other hardware and/or software components.

In addition, the functionality provided by the eye tracking subsystem 135 may, in some embodiments, be distributed in one or more components, and in some embodiments some of the functionality of the eye tracking subsystem 135 may not be provided and/or other additional functionality may be available. It will also be appreciated that, while various items are illustrated as being stored in memory or on storage while being used, these items or portions of them may be transferred between memory and other storage devices for purposes of memory management or data integrity. Thus, in some embodiments, techniques may be performed by hardware that include one or more processors or other configured hardware circuitry or memory or storage, such as when configured by one or more software programs (e.g., by the eye tracking subsystem 135 or it components) and/or data structures (e.g., by execution of software instructions of the one or more software programs and/or by storage of such software instructions and/or data structures). Some or all of the components, systems, and/or data structures may be stored (e.g., as software instructions or structured data) on a non-transitory computer-readable storage medium, such as a hard disk or flash drive or other non-volatile storage device, volatile or non-volatile memory (e.g., RAM), a network storage device, or a portable media article to be read by an appropriate drive (e.g., a DVD disk, a CD disk, an optical disk, etc.) or via an appropriate connection. The systems, components and data structures may also in some embodiments be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). Such computer program products may also take other forms in some embodiments.

FIG. 2 illustrates an embodiment of an environment 200 used with an example HMD device 202 that is coupled to a video rendering computing system 204 via a tethered connection 220 (or a wireless connection in some embodiments) to provide a virtual reality display to a human user 206. The user wears the HMD device 202 and receives displayed information via the HMD device from the computing system 204 of a simulated environment different from the actual physical environment, with the computing system acting as an image rendering system that supplies images of the simulated environment to the HMD device for display to the user, such as images generated by a game program and/or other software program executing on the computing system. The user is further able to move around within a tracked volume 201 of the actual physical environment 200 in this example, and may further have one or more I/O (“input/output”) devices to allow the user to further interact with the simulated environment, which in this example includes hand-held controllers 208 and 210.

In the illustrated example, the environment 200 may include one or more base stations 214 (two shown, labeled base stations 214-a and 214-b) that may facilitate tracking of the HMD device 202 or the controllers 208 and 210. As the user moves location or changes orientation of the HMD device 202, the position of the HMD device is tracked, such as to allow a corresponding portion of the simulated environment to be displayed to the user on the HMD device, and the controllers 208 and 210 may further employ similar techniques to use in tracking the positions of the controllers (and to optionally use that information to assist in determining or verifying the position of the HMD device). After the tracked position of the HMD device 202 is known, corresponding information is transmitted to the computing system 204 via the tether 220 or wirelessly, which uses the tracked position information to generate one or more next images of the simulated environment to display to the user.

There are numerous methods of positional tracking that may be used in the various implementations of the present disclosure, including, but not limited to, acoustic tracking, inertial tracking, magnetic tracking, optical tracking, combinations thereof, etc.

In some implementations, the HMD device 202 includes one or more optical receivers or sensors that may be used to implement tracking functionality or other aspects of the present disclosure. For example, the base stations 214 may each sweep an optical signal across the tracked volume 201. Depending on the requirements of each particular implementation, each base station 214 may generate more than one optical signal. For example, while a single base station 214 can be sufficient for six-degree-of-freedom tracking, multiple base stations (e.g., base stations 214 a, 214 b) may be used in some embodiments to provide robust room-scale tracking for HMD devices and/or peripherals. In this example, optical receivers are incorporated into the HMD device 202 and or other tracked objects, such as the controllers 208 and 210. In some embodiments, optical receivers may be paired with an accelerometer and gyroscope Inertial Measurement Unit (“IMU”) on each tracked device to support low-latency sensor fusion.

In some implementations, each base station 214 includes two rotors that sweep a linear beam across the tracked volume 201 on orthogonal axes. At the start of each sweep cycle, the base station 214 may emit an omni-directional light pulse (referred to as a “sync signal”) that is visible to sensors on the tracked objects. Thus, each sensor computes a unique angular location in the swept volume by timing the duration between the sync signal and the beam signal. Sensor distance and orientation may be solved using multiple sensors affixed to a single rigid body.

The one or more sensors positioned on the tracked objects (e.g., HMD device 202, controllers 208 and 210) may comprise an optoelectronic device capable of detecting the modulated light from the rotor. For visible or near-infrared (NIR) light, silicon photodiodes and suitable amplifier/detector circuitry may be used. Because the environment 200 may contain static and time-varying signals (optical noise) with similar wavelengths to the signals of the base stations 214 signals, in some implementations the base station light may be modulated in such a way as to make it easy to differentiate from any interfering signals, and/or to filter the sensor from any wavelength of radiation other than that of base station signals.

Inside-out tracking is also a type positional tracking that may be used to track the position of the HMD device 202 and/or other objects (e.g., controllers 208 and 210, tablet computers, smartphones). Inside-out tracking differs from outside-in tracking by the location of the cameras or other sensors used to determine the HMD's position. For inside-out tracking, the camera or sensors are located on the HMD, or object being tracked, while in outside-out tracking the camera or sensors are placed in a stationary location in the environment.

An HMD that utilizes inside-out tracking utilizes one or more cameras to “look out” to determine how its position changes in relation to the environment. When the HMD moves, the sensors readjust their place in the room and the virtual environment responds accordingly in real-time. This type of positional tracking can be achieved with or without markers placed in the environment. The cameras that are placed on the HMD observe features of the surrounding environment. When using markers, the markers are designed to be easily detected by the tracking system and placed in a specific area. With “markerless” inside-out tracking, the HMD system uses distinctive characteristics (e.g., natural features) that originally exist in the environment to determine position and orientation. The HMD system's algorithms identify specific images or shapes and use them to calculate the device's position in space. Data from accelerometers and gyroscopes can also be used to increase the precision of positional tracking.

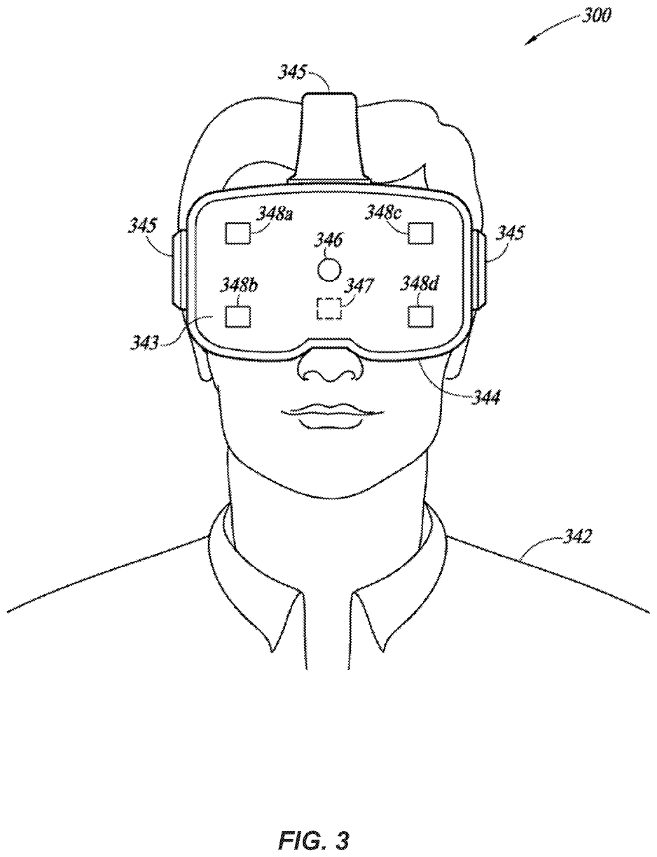

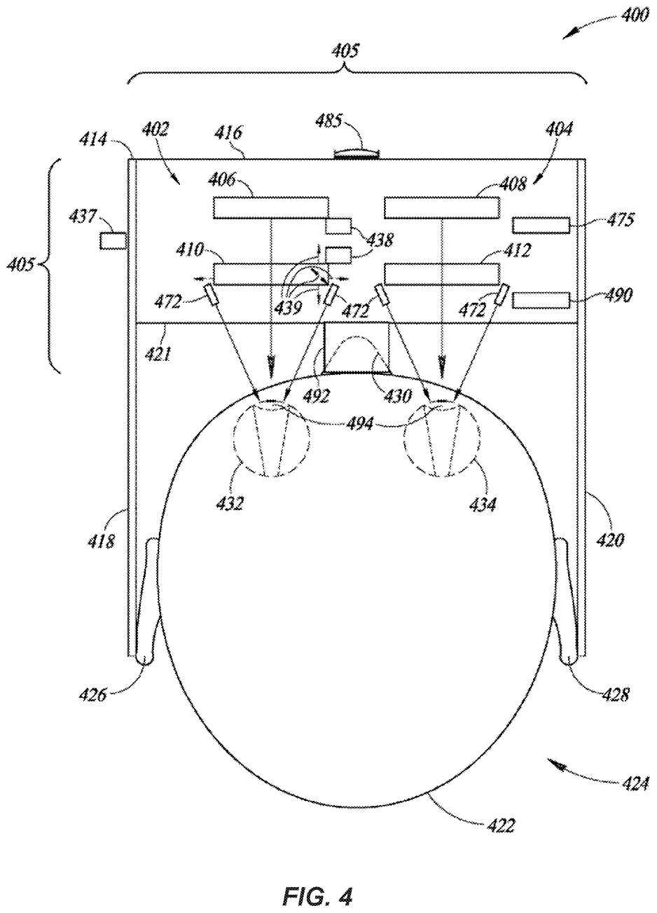

FIG. 3 shows information 300 illustrating a front view of an example HMD device 344 when worn on the head of a user 342. The HMD device 344 includes a front-facing structure 343 that supports a front-facing or forward camera 346 and a plurality of sensors 348 a-348 d (collectively 348) of one or more types. As one example, some or all of the sensors 348 may assist in determining the location and/or orientation of the device 344 in space, such as light sensors to detect and use light information emitted from one or more external devices (not shown, e.g., base stations 214 of FIG. 2). As shown, the forward camera 346 and the sensors 348 are directed forward toward an actual scene or environment (not shown) in which the user 342 operates the HMD device 344. The actual physical environment may include, for example, one or more objects (e.g., walls, ceilings, furniture, stairs, cars, trees, tracking markers, or any other types of objects). The particular number of sensors 348 may be fewer or more than the number of sensors depicted. The HMD device 344 may further include one or more additional components that are not attached to the front-facing structure (e.g., are internal to the HMD device), such as an IMU (inertial measurement unit) 347 electronic device that measures and reports the HMD device's 344 specific force, angular rate, and/or the magnetic field surrounding the HMD device (e.g., using a combination of accelerometers and gyroscopes, and optionally, magnetometers). The HMD device may further include additional components that are not shown, including one or more display panels and optical lens systems that are oriented toward eyes (not shown) of the user and that optionally have one or more attached internal motors to change the alignment or other positioning of one or more of the optical lens systems and/or display panels within the HMD device, as discussed in greater detail below with respect to FIG. 4.

The illustrated example of the HMD device 344 is supported on the head of user 342 based at least in part on one or more straps 345 that are attached to the housing of the HMD device 344 and that extend wholly or partially around the user's head. While not illustrated here, the HMD device 344 may further have one or more external motors, such as attached to one or more of the straps 345, and automated corrective actions may include using such motors to adjust such straps in order to modify the alignment or other positioning of the HMD device on the head of the user. It will be appreciated that HMD devices may include other support structures that are not illustrated here (e.g., a nose piece, chin strap, etc.), whether in addition to or instead of the illustrated straps, and that some embodiments may include motors attached one or more such other support structures to similarly adjust their shape and/or locations to modify the alignment or other positioning of the HMD device on the head of the user. Other display devices that are not affixed to the head of a user may similarly be attached to or part of one or structures that affect the positioning of the display device, and may include motors or other mechanical actuators some embodiments to similarly modify their shape and/or locations to modify the alignment or other positioning of the display device relative to one or more pupils of one or more users of the display device.

FIG. 4 illustrates a simplified top plan view 400 of an embodiment of an HMD device 405 that includes a pair of near-to-eye display systems 402 and 404. The HMD device 405 may, for example, be the same or similar HMD devices illustrated in FIGS. 1-3 or a different HMD device, and the HMD devices discussed herein may further be used in the examples discussed further below. The near-to-eye display systems 402 and 404 of FIG. 4 include display panels 406 and 408, respectively (e.g., OLED micro-displays), and respective optical lens systems 410 and 412 that each have one or more optical lenses. The display systems 402 and 404 may be mounted to or otherwise positioned within a housing (or frame) 414, which includes a front-facing portion 416 (e.g., the same or similar to the front-facing surface 343 of FIG. 3), a left temple 418, right temple 420 and interior surface 421 that touches or is proximate to a face of a wearer user 424 when the HMD device is worn by the user. The two display systems 402 and 404 may be secured to the housing 414 in an eye glasses arrangement which can be worn on the head 422 of a wearer user 424, with the left temple 418 and right temple 420 resting over the user's ears 426 and 428, respectively, while a nose assembly 492 may rest over the user's nose 430. In the example of FIG. 4, the HMD device 405 may be supported on the head of the user in part or in whole by the nose display and/or the right and left over-ear temples, although straps (not shown) or other structures may be used in some embodiments to secure the HMD device to the head of the user, such as the embodiments shown in FIGS. 2 and 3. The housing 414 may be shaped and sized to position each of the two optical lens systems 410 and 412 in front of one of the user's eyes 432 and 434, respectively, such that a target location of each pupil 494 is centered vertically and horizontally in front of the respective optical lens systems and/or display panels. Although the housing 414 is shown in a simplified manner similar to eyeglasses for explanatory purposes, it should be appreciated that in practice more sophisticated structures (e.g., goggles, integrated headband, helmet, straps, etc.) may be used to support and position the display systems 402 and 404 on the head 422 of user 424.

The HMD device 405 of FIG. 4 is arranged to present a virtual reality display to the user, such as via corresponding video presented at a display rate such as 30 or 60 or 90 frames (or images) per second. In some embodiments, the HMD device may present an augmented reality display to the user. Each of the displays 406 and 408 of FIG. 4 may generate light which is transmitted through and focused by the respective optical lens systems 410 and 412 onto the eyes 432 and 434, respectively, of the user 424. The pupil 494 aperture of each eye, through which light passes into the eye, will generally have a pupil size ranging from 2 mm (millimeters) in diameter in very bright conditions to as much as 8 mm in dark conditions, while the larger iris in which the pupil is contained may have a size of approximately 12 mm—the pupil (and enclosing iris) may further move within the visible portion of the eye under open eyelids by several millimeters in the horizontal and/or vertical directions, which will also move the pupil to different depths from the optical lens or other physical elements of the display for different horizontal and vertical positions as the eyeball swivels around its center (resulting in a three dimensional volume in which the pupil can move). The light entering the user's pupils is seen by the user 424 as images and/or video. In some implementations, the distance between each of the optical lens systems 410 and 412 and the user's eyes 432 and 434 may be relatively short (e.g., less than 30 mm, less than 20 mm), which advantageously causes the HMD device to appear lighter to the user since the weight of the optical lens systems and the display systems are relatively close to the user's face, and also may provide the user with a greater field of view. Some embodiments of an HMD device may include various additional internal and/or external sensors.

In FIG. 4, the HMD device 405 includes hardware sensors and additional components, such as to include one or more accelerometers and/or gyroscopes 490 (e.g., as part of one or more IMU units). Values from the accelerometer(s) and/or gyroscopes may be used to locally determine an orientation of the HMD device. In addition, the HMD device 405 may include one or more front-facing cameras, such as camera(s) 485 on the exterior of the front portion 416, and whose information may be used as part of operations of the HMD device, such as for providing AR functionality or positioning functionality. Furthermore, the HMD device 405 may further include other components 475 (e.g., electronic circuits to control display of images on the display panels 406 and 408, internal storage, one or more batteries, position tracking devices to interact with external base stations, etc.). Some embodiments may not include one or more of the components 475, 485 and/or 490. Some embodiments of an HMD device may include various additional internal and/or external sensors, such as to track various other types of movements and position of the user's body, eyes, controllers, etc.

The HMD device 405 further includes hardware sensors and additional components that may be used for determining user pupil or gaze direction, which may be provided to one or more components associated with the HMD device for use. The hardware sensors include one or more eye tracking assemblies 472 of an eye tracking subsystem that are mounted on or near the display panels 406 and 408 and/or located on the interior surface 421 near the optical lens systems 410 and 412 for use in acquiring information regarding the actual locations of the user's pupils 494, such as separately for each pupil in this example.

Each of the eye tracking assemblies 472 may include one or more light sources (e.g., IR LEDs) and one or more light detectors (e.g., silicon photodiodes). Further, although only four total eye tracking assemblies 472 are shown in FIG. 4 for clarity, it should be appreciated that in practice a different number of eye tracking assemblies may be provided. In some embodiments, a total of eight eye tracking assemblies 472 are provided, four eye tracking assemblies for each eye of the user 424. Further, in some embodiments, each eye tracking assembly includes a light source directed at one of the user's 424 eyes 432 and 434, a light detector positioned to receive light reflected by the respective eye of the user, and a polarizer positioned and configured to prevent light that is reflected via specular reflection from being imparted on the light detector.

Information from the eye tracking assemblies 472 may be used to determine and track the user's gaze direction during use of the HMD device 405. Furthermore, in some embodiments, the HMD device 405 may include one or more internal motors 438 (or other movement mechanisms) that may be used to move 439 the alignment and/or other positioning (e.g., in the vertical, horizontal left-and-right and/or horizontal front-and-back directions) of one or more of the optical lens systems 410 and 412 and/or display panels 406 and 408 within the housing of the HMD device 405, such as to personalize or otherwise adjust the target pupil location of one or both of the near-to-eye display systems 402 and 404 to correspond to the actual locations of one or both of the pupils 494. Such motors 438 may be controlled by, for example, user manipulation of one or more controls 437 on the housing 414 and/or via user manipulation of one or more associated separate I/O controllers (not shown). In some embodiments the HMD device 405 may control the alignment and/or other positioning of the optical lens systems 410 and 412 and/or display panels 406 and 408 without such motors 438, such as by use of adjustable positioning mechanisms (e.g., screws, sliders, ratchets, etc.) that are manually changed by the user via use of the controls 437. While the motors 438 are illustrated in FIG. 4 for only one of the near-to-eye display systems, each near-to-eye display system may have its own one or more motors, and, in some embodiments, one or more motors may be used to control (e.g., independently) each of multiple near-to-eye display systems.

In some embodiments, other types of display systems may be used, including with a single optical lens and display device, or with multiple such optical lenses and display devices. Non-exclusive examples of other such devices include cameras, telescopes, microscopes, binoculars, spotting scopes, surveying scopes, etc. Additionally, a wide variety of display panels or other display devices that emit light to form images may be used, which one or more users view through one or more optical lens. In some embodiments, a user may view one or more images through one or more optical lenes that are produced in a manner other than via a display panel, such as on a surface that reflects light from another light source in part or in whole.

### Liquid Lens

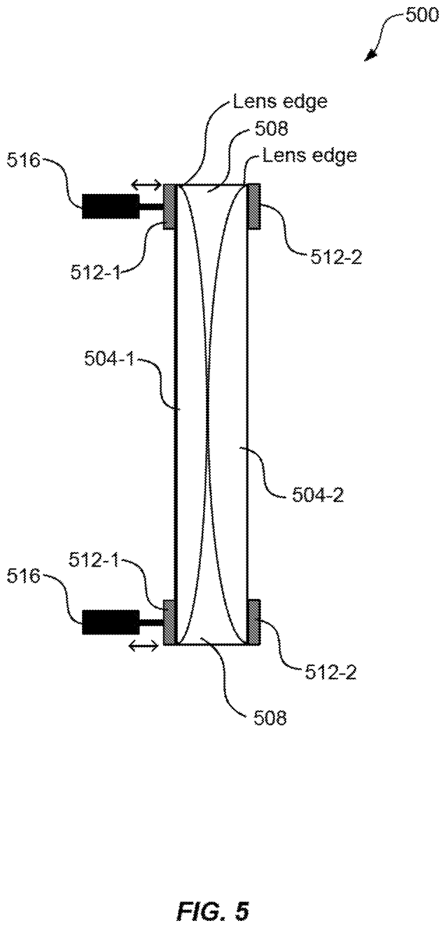

FIG. 5 illustrates a cross-sectional view of an embodiment of an apparatus 500 (e.g., an optical system) for optical correction. The apparatus 500 comprises a first optical element 504-1 and a second optical element 504-2. In this embodiment, the optical elements 504 are plano-convex lenses. As illustrated, the first optical element 504-1 and second optical element 504-2 are arranged with their convex sides facing each other and their planar sides facing outward. As an example, the optical element 504 has a 150 mm radius of curvature and a 50 mm diameter. In some embodiments, the radius of curvature is equal to or greater than 30, 50, 80, 90, 100, 110, 125, 150 and/or equal to or less than 100, 125, 150, 200, 300, or 400 mm. In some configurations, the diameter is equal to or greater than 5, 10, 30 or 50 mm and/or equal to or less than 30, 50, 100, or 200 mm. In some embodiments, the first optical element have a different radius of curvature than the second optical element. In some configurations, the optical elements 504 are bonded together at their respective vertexes such that the convex sides are touching.

A fluid volume 508 is disposed between the first optical element 504-1 and the second optical element 504-2 to form a liquid lens. The fluid within the fluid volume 508 may comprise an index-matching liquid, such as corn syrup, silicone oils, Glycerin, mineral oils, or the like. The liquid may optionally be a non-hazardous materials. In some embodiments, corn syrup is used as an inexpensive, non-hazardous material.

In some embodiments, the optical elements 504 are comprised of a semirigid plastic. This semirigid construction allows the elements to maintain a baseline shape in the absence of external mechanical forces and to resist deformation from gravity regardless of the orientation of the apparatus 500.

A ring mount 512 is used on one or each planar side of the optical element 504. FIG. 5 depicts a first ring mount 512-1 coupled with the first optical element 504-1 and a second ring mount 512-2 coupled with the second optical element 504-2.

To facilitate dynamic optical correction, a plurality of actuators 516 are distributed around a periphery of the optical elements 504. The periphery corresponds to the first and second edges of the optical elements 504, located radially outward from the vertexes. As shown in FIG. 5, the actuators 516 may be coupled to ring mount 512 positioned on the planar sides of the optical elements 504. The plurality of actuators 516 are configured to apply mechanical force (e.g., pressing or pulling) to adjust a distance between the first edge of the first optical element 504-1 and the second edge of the second optical element 504-2. By adjusting this distance at a plurality of locations around the periphery, the apparatus 500 can change one or more optical properties. For example, adjusting the actuators 516 in unison can change the optical power (e.g., provide spherical correction) of the apparatus 500. Alternatively or additionally to adjusting actuators 516 in unison, adjusting the actuators 516 independently or unevenly around the periphery can warp the optical elements 504 to provide astigmatism correction and/or aspheric correction.

In some configurations, the apparatus 500 is sized for integration into a head-mounted display (HMD). The optical elements 504 and the plurality of actuators 516 may be mounted within an eye tube of the HMD using electrical pins or similar mounting mechanisms. Exemplary dimensions for the optical elements 504 include a radius of curvature between 30 mm and 400 mm (e.g., 150 mm) and a diameter between 5 mm and 200 mm (e.g., 50 mm).

Though the example in FIG. 5 is shown with a plano-convex lenses, other lenses and optical features can be used (e.g., biconvex, biconcave, meniscus, flat slide, etc.) can be used. Further the first optical element and the second optical element can be different types of optical elements (e.g., a flat slide and plano-convex, plano-convex and biconcave, both biconvex, etc.).

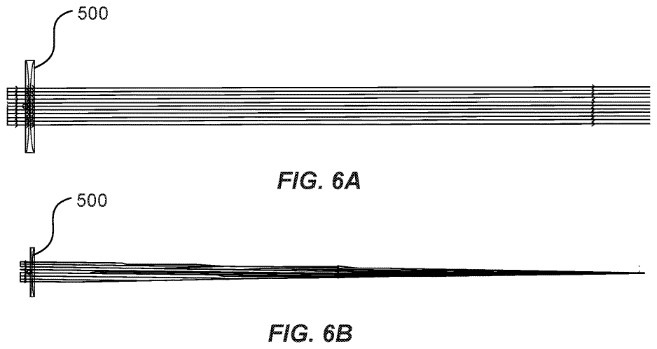

One or more actuators 516 are used to press and/or pull one or more ring mounts 512. If no force is applied by the actuators(s), the optical elements 504 are not flexed, and light passes through the liquid lens basically unaltered (no power change). FIG. 6A depicts an example of no force applied, and the apparatus 500 remains in a neutral state where light passes through basically unaltered.

But if the edges of the optical elements 504 are pushed together (e.g., by the ring mounts), then the liquid lens becomes a positive lens. In FIG. 6B, a 4 diopter focus example is shown.

Similarly, if edges of the optical elements 504 are pulled away from each other (e.g., farther apart), then the liquid lens becomes more negative. The edges of a lens are the outside portion of the optical elements (e.g., radially outward, opposite the vertex).

Mounting to the ring mount can cause deformations that can be calculated (and/or experimentally ascertained) and accounted for. This can be used to account for sag.

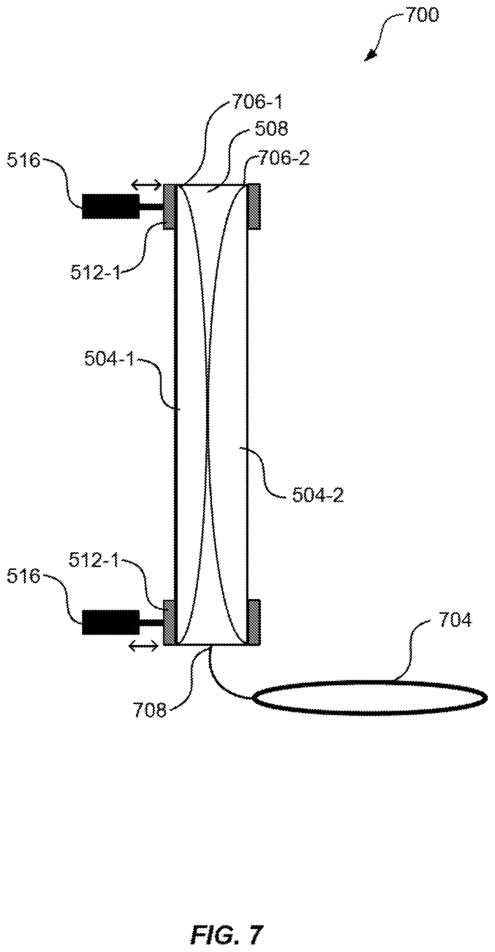

FIG. 7 depicts an apparatus 700 having a reservoir 704. The apparatus 700 is similar to the apparatus 500 in FIG. 5 with the addition of the reservoir 704. In some configurations, the reservoir 704 is used to allow adjustment of an amount of liquid between the first optical element and the second optical element as the edges 706 are brought farther apart or closer together. In FIG. 7, a first edge 706-1 of the first optical element 504-1 and a second edge 706-2 for the second optical element 504-2 are shown. As an example, as the liquid lens is adjusted to be a positive lens (e.g., the first edge 706-1 is moved closer to the second edge 706-2), more fluid is moved into the reservoir 704; as the liquid lens is adjusted to be a negative lens (e.g., the first edge 706-1 is moved farther away from the second edge 706-2), fluid is moved from the reservoir 704 to the fluid volume 508. A port 708 connects the fluid volume 508 with the reservoir 704. The movement of fluid through the port 708 between the fluid volume 508 and the reservoir 704 may be passively driven by pressure differentials within the fluid volume 508 created by the mechanical deformation of the first optical element 504-1 and the second optical element 504-2. For example, as the actuators 516 decrease the distance between the edges 706, the resulting compression of the fluid volume 508 increases internal pressure, forcing fluid through the port 708 and into the reservoir 704. Conversely, as the actuators 516 increase the distance between the edges 706, the expansion of the volume and the restorative elastic force of the semirigid plastic create a lower pressure area that draws fluid from the reservoir 704 back into the fluid volume 508. In some configurations, the reservoir 704 includes a flexible membrane (e.g., silicone elastomers, thermoplastic polyurethane, or fluoroelastomers).

In some configurations, astigmatism is corrected for, in addition to or in lieu of power. For example, a number (e.g., 2, 3, 4, 6, 9) of actuators 516 are used on each ring mount 512, wherein the actuators 516 are evenly distributed around the edge 706 of the lens. The actuators 516 are then adjusted to warp the optical element as actuators 516 apply forces on the lens (optical element 504) unevenly around the edge 706 of the lens. In some configurations, models are run to see where the actuators can push and/or pull to create a desired correction for astigmatism. In some configurations, aspheric correction is also adjusted for. For two actuators, the two actuators can be arranged to be rotated around the ring mount to compensate for different angles of astigmatism (e.g., the two actuators are rotated to a desired angle and then one actuator pushes in or pulls out while the other actuator stays in position, pushes in, or pulls out). Models can lead to an equation that defines a force and/or actuator displacement value to prescription (e.g., a transfer function) for a given optical prescription. For example, the models take into account Young's modulus for one or more semirigid plastic components, fluid viscosity, and/or actuator displacement per unit of force, actuator displacement value(s), and/or optical power of the lens. In some embodiments, actuator displacement is mapped to optical power. Table 1 provides an example embodiment of actuator displacement to optical power.

TABLE I
Actuator Displacement and Optical Power of lens

| Optical Power (Diopters) | Actuator Displacement (mm) |
|---|---|
| +6 | 1.00 (pushing edges together) |
| +5.5 | 0.91 |
| +5.0 | 0.83 |
| +4.5 | 0.74 |
| +4.0 | 0.66 |
| +3.5 | 0.57 |
| +3.0 | 0.49 |
| +2.5 | 0.47 |
| +2.0 | 0.32 |
| +1.5 | 0.24 |
| +1.0 | 0.16 |
| +0.5 | 0.08 |
| 0.0 | 0 (neutral state) |
| −1.0 | −0.16 (pulling edges apart) |
| −2.0 | −0.32 |
| −3.0 | −0.48 |
| −4.0 | −0.62 |
| −5.0 | −0.78 |
| −6.0 | −0.92 |
| −7.0 | −1.07 |
| −8.0 | −1.22 |
| −9.0 | −1.36 |
| −10.0 | −1.50 |

In Table 1, a positive optical power is created by pushing edges together, and a negative optical power is created by pulling edges apart. The example in Table 1 assumes a total actuator travel of 2.5 mm, and can be modeled as a second-order polynomial (quadratic), such as below:

$$Displacement ( Δ z ) = {a ( D )}^{2} + b ( D ) + c$$

Where:
D is the diopter value,
a accounts for the non-linear stiffness of the semirigid plastic,
b is the primary linear sensitivity, and
c is the offset (the actuator position at the 0.0 diopter neutral state)

The actuators can be adjusted in unison to correct for power, and then the actuators can be run independently to correct for astigmatism and/or aspheric adjustments. A user interface can be used to guide a user through adjustments. For example, a first sheet can be presented on the VR display and power is adjusted first, with electronics driving the actuators in unison. When a graphic on the first sheet can no longer be brought into greater focus, then a second sheet is presented on the VR display with lines (e.g., orthogonal lines) and adjustment are made by independently adjusting the actuators to correct for astigmatism. In some cases, adjustment is made electronically. In some cases, adjustments are made manually, e.g., with the user twisting knobs (e.g., one knob for power, and one or more knobs for correcting astigmatism). In another example, the VR headset walks a user through an adjustment process by asking the user a set of questions (e.g., is a graphic or image more clear for option 1 or option 2 as the liquid lens is adjusted). In another example, the user can slide a horizontal graphical bar in a user interface to correct for power and then rotate a circle in the user interface to correct for astigmatism, while the user is watching one or more graphics presented the VR display.

In some configurations, only one actuator is used to apply an even force to a ring (e.g., for adjusting just power). For example, a cam system or a rigid frame with guide rods is used with the one actuator to apply a substantially uniform force around the edge of the lens.

In some cases, a user or someone else can send an optical prescription from a mobile device (e.g., from a smart phone using Bluetooth) to the VR headset and the VR headset adjusts the liquid lens to that prescription (e.g., based on models created previously).

Some liquid lenses use a liquid that can be modified based on a magnetic field (e.g., the liquid comprises magnetic material). This can limit a size of a diameter of a lens. The liquid lens in FIGS. 5 and 7 use a mechanical force applied to a plastic lens, which can be made much larger than lenses that use magnetic fields to change their shapes. The plastic lens can be semirigid, meaning it keeps its shape while no external mechanical forces (e.g., besides mounting force of mount) are applied and/or keeps its shape under the force of gravity regardless of an orientation of the lens with respect to the force of gravity.

The liquid lens in FIGS. 5 and 7 can optionally be low cost (e.g., molded plastic lenses with corn syrup) and can basically be a reasonable diameter for use by a person.

Experimentally, the liquid lens shown in FIGS. 5 and 7 can be used to correct power from −10 diopters to +6.

The liquid lens in FIGS. 5 and 7 can optionally be used as the optical lens 410 and/or 412 in FIG. 4. Electrical pins can be used to mount the liquid lens in the eye tube of the VR headset.

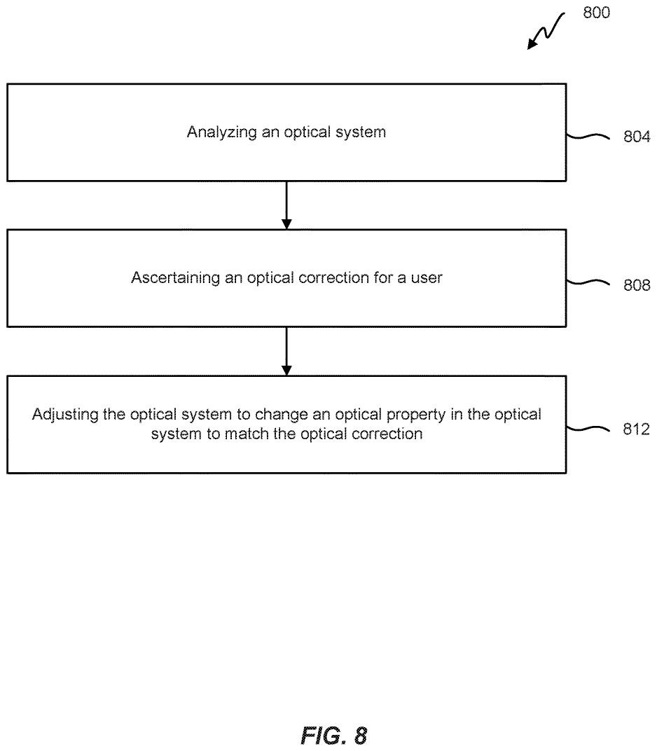

FIG. 8 illustrates a flowchart depicting an embodiment of a process 800 for optical correction using an adjustable liquid lens system. The process 800 provides an example for dynamically tailoring the optical properties of the system to meet the specific physiological needs of a user, such as a wearer of a head-mounted display (HMD).

At block 804, process 800 begins by analyzing an optical system in a first state. The optical system comprises a first optical element (e.g., element 504-1), a second optical element (e.g., element 504-2), and a fluid volume (e.g., fluid volume 508) disposed between the two optical elements. In some embodiments, this first state may be a neutral or “un-flexed” state where no mechanical force is applied to the optical elements, allowing light to pass through the system substantially unaltered. In some configurations, this optical system is integrated within a head-mounted display housing, such as within an eye tube of the HMD.

At block 808, an optical correction for a user is ascertained. This ascertainment may occur through various interactive or automated processes. For example, the system may present one or more graphics (e.g., text, sheets, or lines) on a display of an HMD and receive user input via a graphical user interface. In some embodiments, ascertaining the optical correction may comprise receiving an optical prescription from an external mobile device, such as a smartphone, via a wireless communication link (e.g., Bluetooth).

At block 812, the optical system is adjusted to change an optical property to match the ascertained optical correction. This adjustment can be performed by a plurality of actuators (e.g., actuators 516) distributed around a periphery of the optical elements. The actuators are configured to adjust a distance between the first edge of the first optical element and the second edge of the second optical element at a plurality of locations. This mechanical adjustment physically deforms the semirigid optical elements, which in turn changes the shape and volume of the fluid disposed between them.

Depending on the correction desired, the actuators may be driven in unison to adjust optical power or driven independently/unevenly to warp the optical elements. Such uneven application of force allows the system to correct for astigmatism or provide aspheric adjustments by creating an asymmetric lens profile. During this adjustment process, fluid may be moved between the primary fluid volume and a reservoir in fluid communication with the volume to accommodate the changing distance between the optical element edges.

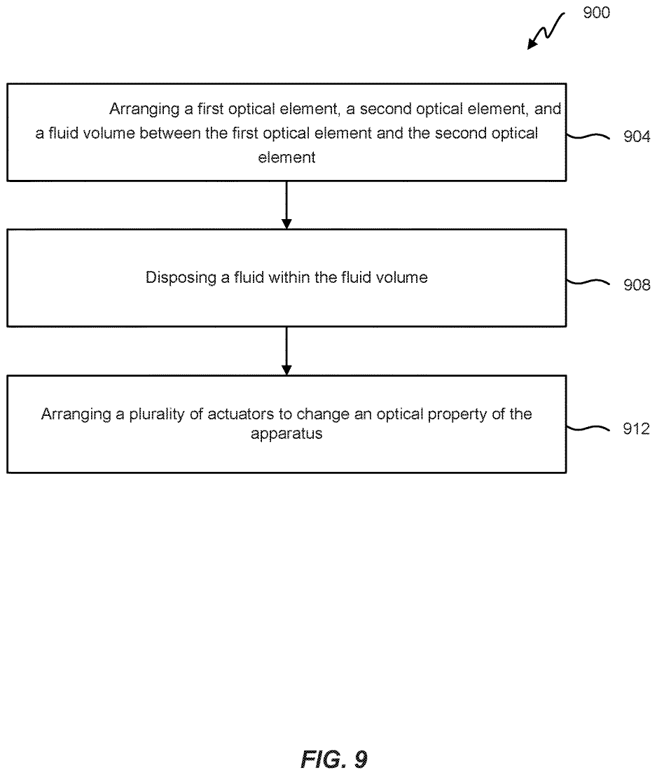

FIG. 9 illustrates a flowchart of an embodiment of a process 900 for manufacturing an apparatus for optical correction, such as the adjustable liquid lens apparatus 500 described in FIG. 5. Process 900 can be for the assembly of a mechanical and optical components to create a system capable of dynamic vision correction.

At block 904, process 900 begins by arranging a first optical element (e.g., element 504-1), a second optical element (e.g., element 504-2), and a fluid volume (e.g., fluid volume 508) between the first optical element and the second optical element. As illustrated in the embodiment of FIG. 5, this may include arranging the optical elements such that their convex sides face each other and their planar sides face outward. In some configurations, this arranging step optionally comprises bonding the first optical element to the second optical element at a vertex of the first optical element and a vertex of the second optical element. The first and second optical elements may optionally be molded as a single piece.

At block 908, a fluid is disposed within the fluid volume. The fluid may comprise an index-matching liquid, such as corn syrup or other suitable transparent fluids. The process may optionally comprise providing a reservoir in fluid communication with the fluid volume. This reservoir is configured to allow for the adjustment of an amount of fluid within the active fluid volume between the optical elements as the distance between the edges of the elements is mechanically adjusted.

At block 912, a plurality of actuators (e.g., actuators 516) are arranged at a periphery of at least one optical element. This step may optionally further comprise attaching a first ring mount (e.g., 512-1) to a planar side of the first optical element and/or a second ring mount (e.g., 512-2) to a planar side of the second optical element. Arranging the actuators may optionally comprise coupling the plurality of actuators to the first and/or second ring mounts such that they are configured to apply mechanical force to the first and second edges. This arrangement allows the actuators to adjust the distance between the edges at a plurality of locations to change an optical property of the apparatus, such as optical power, astigmatism, or aspheric correction.

The above description is meant to provide some examples. Several variations are contemplated. For example, the first optical element 504-1 and the second optical element 504-2 in FIG. 5 can be molded as unitary piece (e.g., instead of being bonded together). In some cases, an adjustable ring is disposed between the first optical element and the second optical element, and concentric with the first optical element and the second optical element; as the adjustable ring is constricted (e.g., decreases in diameter), the adjustable ring pushes edges of the optical elements further apart (e.g., similar to a wedge). In another example, the first optical element is a lens, and the second optical element is a slide (a flat plane), making it easier to align the slide to the lens as compared to aligning two lenses; and/or actuators are applied to the slide, the plastic lens, or both. There are applications of the liquid lens outside augmented reality (e.g., using the liquid lens in a pair of glasses).

The embodiments were chosen and described in order to explain the principles of the invention and practical applications to thereby enable others skilled in the art to best utilize the invention in various embodiments and with various modifications as are suited to the particular use contemplated.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc.

A recitation of “a”, “an”, or “the” is intended to mean “one or more” unless specifically indicated to the contrary.

All patents, patent applications, publications, and descriptions mentioned here are incorporated by reference in their entirety for all purposes. None is admitted to be prior art.

What is claimed is:

1. An apparatus for optical correction, comprising:
a first optical element having a first edge;
a second optical element having a second edge;
a fluid volume disposed between the first optical element and the second optical element; and
a plurality of actuators distributed around a periphery of at least one of the first optical element or the second optical element, the plurality of actuators configured to adjust a distance between the first edge and the second edge at a plurality of locations to change an optical property of the apparatus.

2. The apparatus of claim 1, wherein the change in the optical property includes at least one of a change in optical power, a correction for astigmatism, or a spherical correction.

3. The apparatus of claim 1, wherein the first optical element and the second optical element are plano-convex lenses arranged with convex sides facing each other and planar sides facing outward.

4. The apparatus of claim 3, wherein the first optical element and the second optical element are arranged with convex sides touching each other.

5. The apparatus of claim 1, further comprising a reservoir in fluid communication with the fluid volume, the reservoir configured to adjust an amount of fluid between the first optical element and the second optical element as the distance between the first edge and the second edge is adjusted.

6. The apparatus of claim 1, further comprising a first ring mount positioned on a planar side of the first optical element and a second ring mount positioned on a planar side of the second optical element, wherein the plurality of actuators are configured to apply force to at least one of the first ring mount or the second ring mount.

7. The apparatus of claim 1, wherein the plurality of actuators are evenly distributed around the periphery and are configured to apply forces unevenly to warp at least one of the first optical element or the second optical element to correct for astigmatism.

8. The apparatus of claim 1, wherein the first optical element comprises a lens and the second optical element comprises a flat plane slide.

9. The apparatus of claim 1, wherein the first optical element and the second optical element are comprised of a semirigid plastic configured to maintain a shape in the absence of external mechanical forces.

10. The apparatus of claim 1, further comprising a head-mounted display housing, wherein the first optical element, the second optical element, and the plurality of actuators are mounted within an eye tube of the head-mounted display housing.

11. A method for optical correction, comprising:
analyzing an optical system in a first state, wherein the optical system comprises a first optical element, a second optical element, and a fluid volume disposed between the first optical element and the second optical element;
ascertaining an optical correction for a user; and
adjusting, by a plurality of actuators distributed around a periphery of at least one of the first optical element or the second optical element, a distance between a first edge of the first optical element and a second edge of the second optical element at a plurality of locations to change an optical property of the optical system to match the optical correction, wherein the adjusting changes the fluid volume between the first optical element and the second optical element.

12. The method of claim 11, wherein the optical system is integrated within a head-mounted display.

13. The method of claim 11, wherein the adjusting further comprises applying forces unevenly around the periphery of at least one of the first optical element or the second optical element to warp the optical system to correct for astigmatism.

14. The method of claim 11, wherein the adjusting further comprises moving fluid between the fluid volume and a reservoir in fluid communication with the fluid volume.

15. The method of claim 11, wherein analyzing the optical system and ascertaining the optical correction further comprises presenting a graphic on a display and receiving user input via a user interface while the plurality of actuators adjust the optical property until the graphic is brought into focus.

16. The method of claim 11, wherein ascertaining the optical correction comprises receiving an optical prescription from a mobile device.

17. A method of manufacturing an apparatus for optical correction, comprising:
arranging a first optical element, a second optical element, and a fluid volume between the first optical element and the second optical element;
disposing a fluid within the fluid volume; and
arranging a plurality of actuators at a periphery of at least one of the first optical element or the second optical element such that the plurality of actuators are configured to adjust a distance between a first edge of the first optical element and a second edge of the second optical element at a plurality of locations to change an optical property of the apparatus.

18. The method of claim 17, wherein arranging the first optical element and the second optical element comprises bonding the first optical element to the second optical element at a vertex of the first optical element and a vertex of the second optical element.

19. The method of claim 17, further comprising providing a reservoir in fluid communication with the fluid volume, the reservoir configured to allow adjustment of an amount of the fluid within the fluid volume as the distance between the first edge and the second edge is adjusted.

20. The method of claim 17, further comprising attaching a first ring mount to a planar side of the first optical element and a second ring mount to a planar side of the second optical element, wherein arranging the plurality of actuators comprises coupling the plurality of actuators to the first ring mount and the second ring mount to apply mechanical force to the first edge and the second edge.
